(19) United States
(12) Patent Application Publication
(10) Pub. No.: US 2008/0050961 A1
(43) Pub. Date: Feb. 28, 2008

(54) Electrical connector with improved latching structure

(75) Inventors: Lewis R. Johnson, Dover, PA (US); Chun-Hsiung Hsu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/509,102

(22) Filed: Aug. 24, 2006

(51) Int. Cl. H01R 13/627

(52) U.S. Cl. 439/352

(57) ABSTRACT

An electrical connector (100) includes a housing (10) for receiving a number of connector modules (11), and a latching member (6) rotatably mounting on the housing (10). The latching member (6) includes an intermediate portion (61) defining a pivotable portion therewith and an engagement portion (62) extends from the intermediate portion (61) for engaging to a complementary connector. The latching member (6) also includes an arc-shaped actuating portion (63) extending from the intermediate portion (61) opposite to the engagement portion (62) and provides biasing force by itself inflection.

### BACKGROUND OF THE INVENTION

1. Field of the Invention

The present invention relates generally to an electrical connector, and particularly to a latching structure securing the connection between the electrical connector and a mated complementary connector.

2. Description of Prior Art

Backplane connectors are generally mounted on printed circuit boards used in high-speed and high-density communication system. Cable connectors are often provided to mate with the backplane connectors. It is common to employ a latching member to secure the connection between the backplane connector and the cable connector.

One such latching assembly is disclosed in U.S. Pat. No. 6,371,788, issued on Apr. 16, 2002. In this patent, a latching assembly for securing a plurality of connector modules to a mating connector in mating engagement includes a retainer member that engages and holds the plurality of connector modules together as a block. A latching lever is movably mounted to the retainer member and has an elongated body portion extending between two opposing ends. A first ends of the latching lever is a latching end disposed in opposition to the mating connector, a second end is an activating end manipulatable by a user to urge said first end into and out of engagement of the mating connector. A clip member movably attaches the latching lever to the retainer member. A biasing member is stamped from the lever body portion of the latching lever between the clip member and the second end for applying a biasing force to the latching lever to constantly urge the latching lever into an engagement position.

However, the biasing force is insufficient to secure the connector modules to the mating connector. Moreover, it is unreliable that the lever is fixed on the retainer member by a clip. Further, the complex latching assembly adds difficulties to manufacture and increases the product cost correspondingly.

Therefore, it's desirable to provide an improved latching structure to the connector to overcome the aforementioned disadvantages.

### SUMMARY OF THE INVENTION

It is therefore a general object of the present invention to provide an effective latching structure providing enough biasing force to ensure a firmly connection between mated complementary connectors.

It is another object of the present invention to provide an effective latching structure with simple configuration and easily to manufacture.

In order to achieve such objects set forth, an electrical connector having an improved latching structure according to the present invention comprises a housing receiving a plurality of connector modules and hold the connector modules as a block, and a latching member for rotatably mounting to the housing. The latching member includes an intermediate portion having a pair of opposite cylindrical ribs thereon defining a pivotable portion therewith, a engagement portion extends from the intermediate portion for engaging to a complementary connector, and an actuating portion extending from the intermediate portion opposite to the engagement portion, which is manipulated by an operator to force the engagement portion to engage to or disengage from the complementary connector. The actuating portion has an end abutting against the housing and has an inflectable arc shape configuration providing enough biasing force by itself.

These and other objects, features and advantages of the present invention will be clearly understand through consideration of the following description.

### BRIEF DESCRIPTION OF THE DRAWING

The features of the present invention which are believed to be novel are set forth with particularity in the appended claims. The present invention, together with its objects and the advantages thereof, may be best understood by reference to the following description taken in conjunction with the accompanying drawings in which:

FIG. 1 is a perspective view of an electrical connector having an improved latching structure in accordance with the principle of the present invention;

FIG. 2 is a perspective view of the electrical connector with connector modules being exploded therefrom;

FIG. 3 is an explosive view of the connector;

FIG. 4 is another explosive view of the connector;

FIG. 5 is a side plan view of the connector showing the latching structure in a latching position; and

FIG. 6 is a view similar to FIG. 5 showing the latching structure in an unlatched position.

### DESCRIPTION OF THE PREFERRED EMBODIMENT

Reference will now be made in detail to the preferred embodiment of the present invention.

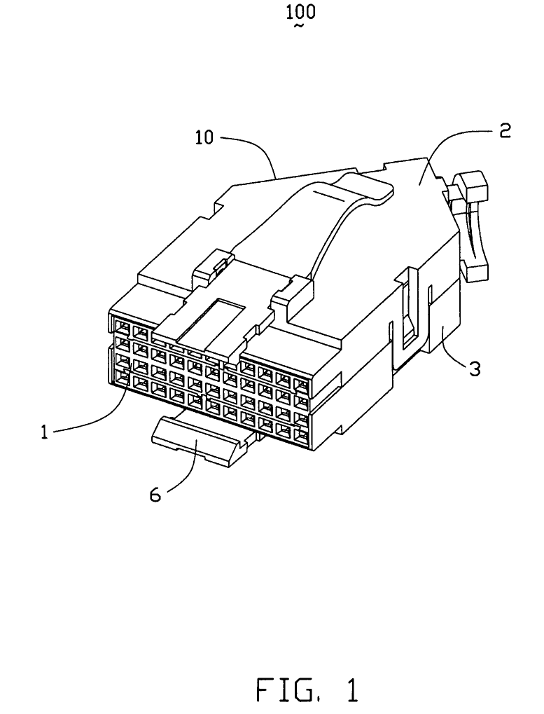

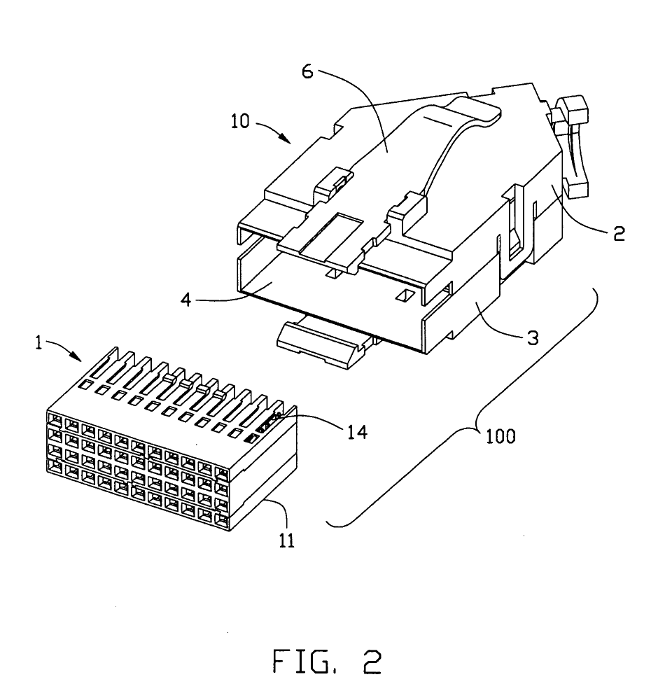

As shown in FIG. 1 and FIG. 2, an electrical connector 100 in accordance with the present invention is typically terminated with a plurality of wires or cables (not shown) and mates with a backplane connector mounted on a printed circuit board (not shown). The electrical connector 100 includes a plurality of electrical connector modules 11 assembled together as a connector block 1 for engaging with the complementary backplane connector. In the preferred embodiment, the connector block 1 includes two opposite “side modules” and one “central module” sandwiched between the two “side modules”. Each side module 11 has one row of insulated contacts 14 (only one illustrating contact is shown) each electrically connecting to a corresponding wire. The electrical connector 100 forms a housing or a cover 10. The housing 10 has a first housing member 2 and a second housing member 3 which mate with each other and define a receiving space 4 therebetween for receiving the connector block 1. The electrical connector 100 also includes a latching member 6 mounted on the housing 10 for securing the connection between the connector 100 and the complementary connector during engagement.

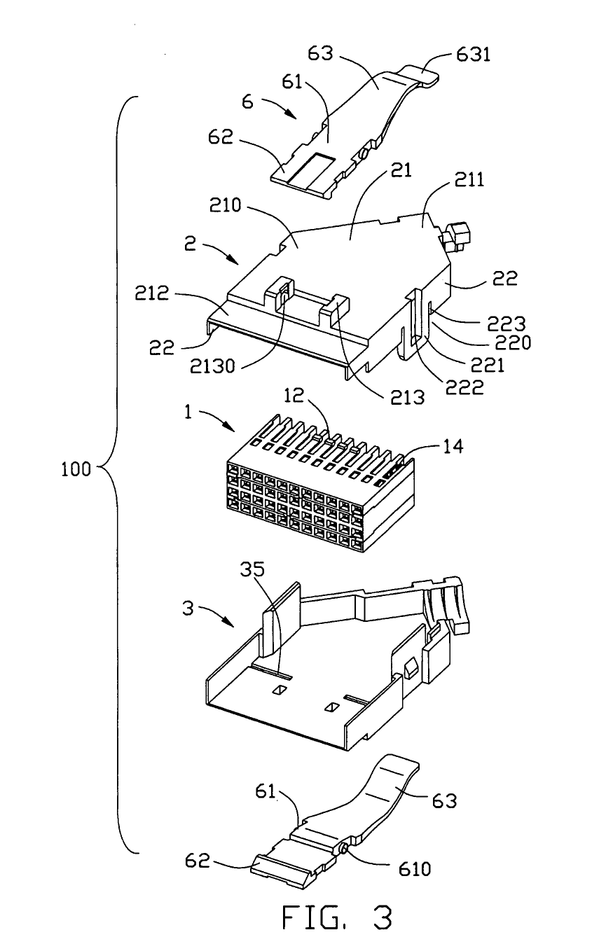

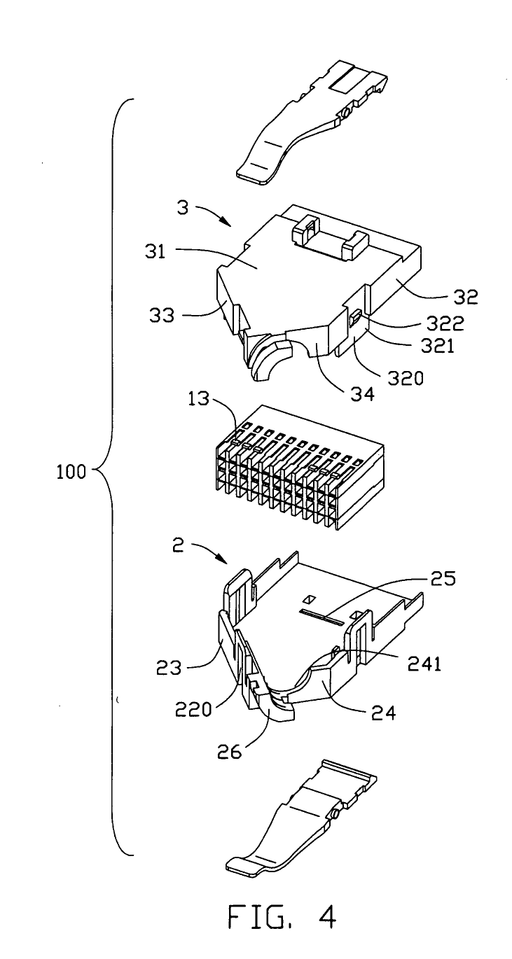

Referring to FIG. 3, the first housing member 2 includes a main body 21 comprising a rectangular section 210 and a triangular section 211. The rectangular section 210 defines a recess 212. A pair of protrusions 213 is positioned adjacent to the recesses 212. Each of the protrusion 213 defines a cavity 2130 functioning as fulcrums. Two sidewalls 22 vertically extend from two side edges of the rectangular section 210 and each has a locking member 220. The locking member 220 includes a resilient arm member 221 extending beyond the bottom side of the sidewall 22, and an opening 222 defined thereon. A pair of slits 223 is oppositely positioned beside the resilient arm member 221 so as to increase the spring force of the resilient arm member 221. In addition, the main body 21 has an elongate groove 25 (see more clearly in FIG. 4) defined on its inner surface for mating with ribs 12 formed on the connector block 1. Two inclined sidewalls 23,24 also vertically extend from two side edges of the triangular section 211 and intersect with each other. The inclined wall 23 is provided with the locking member 220 as same as that of the sidewall 22. Further, the inclined wall 24 defines a half-round opening 241, and a neck portion 26 thereon. The half-round opening 241 and the neck portion 26 are used to manage the wires connected to the connector modules 11.

Now reference made to FIG. 4, the second housing member 3 is capable of cooperating with the first housing member 2 and has a similar configuration with the first housing 2 except for locking members 320 on two sidewalls 32 and an inclined wall 34. The locking member 320 includes a planar 321 with a cam 322 formed thereon for engaging within the opening 222 of the first housing member 2 thereby to firmly assemble the first and second housing members 2, 3 together. Two elongate grooves 35 are defined on the inner surface of the main body portion 31 for receiving second ribs 13 formed on the connector block 1 to thereby secure the modules 11 in the housing 10.

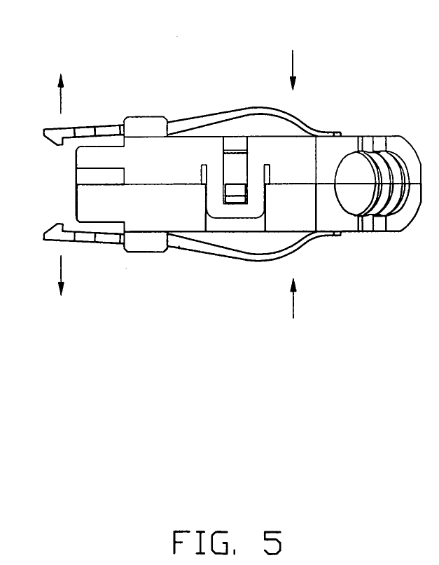

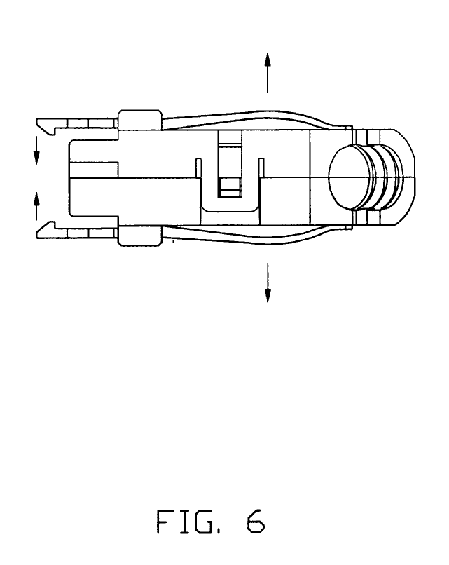

As mentioned above, the present invention is aimed at an improved latch structure providing enough biasing force for reliably retaining the connector block 1 in place within the complementary connector. As shown in FIG. 2, one preferred embodiment of the improved latching structure comprises a pair of latching members 6. The latching members 6 have an intermediate portion 61 pivotally mounted on the first housing member 2 and second housing member 3 respectively. The intermediate portion 61 provides two cylindrical ribs 610 on both sides thereof. The ribs 610 are rotatably received in the cavities 2130 of the protrusions 213 defining the intermediate portion 61 as a pivotable portion. The latch member 6 further has an engagement portion 62 extending from the intermediate portion 61. The engagement portion 62 illustrated as a hook for engaging with the complementary connector, while the complementary connector may have a recess on its side surface to receive the engagement portion 62. The latching member 6 has an actuating portion 63 extending from the intermediate portion 61 opposite to the engagement portion 62. The actuating portion 63 is provided with an injectable arc shape that has a front end 631 abutting against an outer surface of the first/second housing members 2, 3. When pressed by an operator, as best shown in FIG. 5 and FIG. 6, the actuating portion 63 will inflect toward the connector block 1 and provides biasing force making the latching member 6 rotate around the pivotable portion, which result in the engagement portion 62 coming out of the receptacle. Vice versa, the actuating portion 63 restores and forces the engagement portions 62 enter into the engagement position to thereby lock the connector module 1 and the complementary connector together.

While the preferred embodiment of the invention have been shown and described, it will be apparent to those skilled in the art that changes and modifications may be made therein without departing from the spirit of the invention, the scope of which is defined by the appended claims.

We claim:

1. An electrical connector adapted for mating with a complementary connector, comprising:
a plurality of connector modules retaining a plurality of contacts therein;
a housing defining a receiving space receiving said plurality of connector modules;
a pair of latching members pivotably mounted on opposite sides of said housing, and each integrally including an intermediate portion defining a pivotable portion, an engagement portion extending from said intermediate portion, and an actuating portion extending from said intermediate portion opposite to said engagement portion, said actuating portion having an inflectable arc shape configuration capable of being manipulated by an operator to force said engagement portion engaged into or disengage from the mating connector.

2. The electrical connector of claim 1, wherein said intermediate portion has a pair of opposite cylindrical ribs thereon defining said pivotable portion.

3. The electrical connector of claim 2, wherein said housing defines a pair of cavities receiving said pair of opposite cylindrical ribs.

4. The electrical connector of claim 2, wherein said housing has a pair of protrusions each defining a cavity for receiving corresponding cylindrical rib.

5. The electrical connector of claim 1, wherein said housing comprises a first housing member and a second housing member mechanically secured with each other.

6. The electrical connector of claim 5, wherein said first housing member is provided with a resilient arm member defining a opening thereon, and said second housing member is provided a cam locking with said opening of said resilient member.

7. The electrical connector of claim 5, wherein said first and second housing member each define at least one groove, and said electrical modules define a set of ribs extending into said grooves of said first and second housing members.

9. A cable end connector terminated with a plurality of wires, which is adapted for mating with a complementary board mounted connector, comprising:
an insulative housing defining a receiving space;
a plurality of rows of insulated contacts electrically connecting to corresponding wires;
a pair of latching members pivotably mounted to opposite sides of said housing and extending parallelly along a mating direction, each latching member integrally comprising a pivotable portion assembled to said housing, a latching end for holding said complementary connector when mated, and a deflectable arc portion opposite to said latching end for providing a resilient force to drive said latching end engage with or disengage from said complementary mating connector.

10. The cable end connector as claimed in claim 9, wherein said pivotable portion defines a pair of opposite cylindrical ribs.

11. The cable end connector as claimed in claim 10, wherein said housing defines a pair of cavities rotatably receiving said pair of opposite cylindrical ribs.

12. The cable end connector as claimed in claim 10, wherein said housing has a pair of protrusions defining a pair of cavities receiving said pair of opposite cylindrical ribs.

13. The cable end connector as claimed in claim 9, wherein said housing defines a neck portion for managing said plurality of wires connected to said contacts.

14. The cable end connector as claimed in claim 9, wherein said housing includes a first and a second housing halves cooperating with each other.

15. The cable end connector as claimed in claim 14, wherein said first housing half is provided with a resilient arm member defining an opening thereon, and said second housing half is provided with a cam thereon and locking within said opening of said resilient member.

16. The cable end connector as claimed in claim 14, further comprising a plurality of connector modules in which said contacts are received.

17. The cable end connector as claimed in claim 16, wherein said connector modules are enclosed by said housing halves.

18. A cable end connector terminated with a plurality of wires, which is adapted for mating with a complementary board mounted connector, comprising:
an insulative housing defining a receiving space in a front portion;
a plurality of rows of insulated contacts electrically connecting to corresponding wires;
at least one latching member pivotably mounted to one side of said housing and extending parallel along a mating direction, said latching member integrally comprising a pivotable portion with a pivot axis thereof assembled to said housing, a latching end for holding said complementary connector when mated, and a deflectable arc portion opposite to said latching end for providing a resilient force to drive said latching end to be engaged with or disengaged from said complementary mating connector; wherein
the arc portion includes unitarily a distal end constantly abutting against the side of the housing, said distal end moving rearwardly when said arc portion is deflected to have the latch end move outwardly.

19. The connector as claimed in claim 18, wherein said further defines an oblique cable exit in a rear portion, and a semi-circular neck is formed around a rear half periphery of a round opening at said cable exit.
